(19) United States
(12) Patent Application Publication
(10) Pub. No.: US 2026/0202866 A1
(43) Pub. Date: Jul. 16, 2026

(54) Water Heating System with a Valve Assembly

(71) Applicant: Rheem Manufacturing Company, Atlanta, GA (US)

(72) Inventors: Cameron Joseph Wright, Indianapolis, IN (US); James Michael Reagin, Noblesville, IN (US); John Relman Bohlen, Solon, OH (US); Matthew Richard Fehlner, Berea, OH (US); Matthew Vern Force, Bath, OH (US); Alexander G. Oldja, Wadsworth, OH (US)

(21) Appl. No.: 19/449,244

(22) Filed: Jan. 14, 2026

Related U.S. Application Data
(60) Provisional application No. 63/746,094, filed on Jan. 16, 2025.

(51) Int. Cl. G05D 23/13; F24D 19/10; F24H 15/12

(52) U.S. Cl. CPC G05D 23/1393; F24D 19/1006; F24H 15/12

(57) ABSTRACT

A water heating system is disclosed. The water heating system may include a valve assembly configured to receive cold water and hot water, blend the cold water and the hot water, and output a blended water at a desired water temperature based on a valve component position. The water heating system may further include a position sensor configured to monitor a valve component position. The water heating system may further include a controller configured to cause movement of a valve component to a desired valve component position. The controller may verify that the valve component position is equivalent to the desired valve component position based on inputs obtained from the position sensor and perform a predetermined action when the valve component position is different from the desired valve component position.

### CROSS-REFERENCE TO RELATED APPLICATIONS

The present application claims priority to and the benefit of U.S. provisional application No. 63/746,094, filed Jan. 16, 2025, which is hereby incorporated by referenced herein in its entirety.

### FIELD

The present disclosure relates to water heating systems and more particularly to water heating systems with a valve assembly.

### BACKGROUND

Water heating systems are generally used to provide a supply of heated water. Water heating systems are used in a variety of applications including residential, commercial, and industrial applications. A conventional water heating system may include a mixing valve that may regulate the temperature of water output from the water heating system. The mixing valve typically receives a feed of cold water and hot water and mixes them at a predefined ratio to output water at a desired water temperature.

In some instances, the mixing valve may develop faults (e.g., due to scaling, debris accumulation, etc.), which may lead to malfunctioning of the mixing valve. For example, the mixing valve may get stuck or jammed at a position, due to which the mixing valve may not be able to regulate the temperature of the output water efficiently.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a first schematic illustration of an example water heating system in accordance with one or more embodiments of the present disclosure.

FIG. 2 depicts a second schematic illustration of an example water heating system in accordance with one or more embodiments of the present disclosure.

FIG. 3 depicts a block diagram of a controller in accordance with one or more embodiments of the present disclosure.

FIG. 4 depicts a flow diagram of an example method to control a water heating system in accordance with one or more embodiments of the present disclosure.

### DETAILED DESCRIPTION

The present disclosure is directed towards a water heating system that may include a valve assembly. The valve assembly may blend cold water from a cold water supply and hot water from a system water tank, and output water at a desired water temperature.

The valve assembly may include a valve component that may be configured to move longitudinally and/or rotate axially to enable the valve assembly to mix / blend optimal portions of the hot and cold water to output the water at the desired water temperature. In certain embodiments, the valve component may be a spool, a rotating disc, and/or the like, which may be part of the valve. The water heating system may further include an actuator and a controller that may control the valve assembly operation. The actuator may be configured to trigger/actuate a mechanical movement of the valve component (e.g., the spool or the rotating disc) to a desired valve component position, based on command signals (e.g., a “first command signal”) obtained from the controller.

The system may further include a position sensor that may be configured to monitor a real-time position of the valve component (or a “real-time valve component position”). The controller may obtain inputs associated with the real-time valve component position from the position sensor and determine whether the real-time valve component position is equivalent to the desired valve component position. Stated another way, the controller checks, based on the inputs obtained from the position sensor, whether the actuator is able to correctly move the valve component to the desired valve component position after receiving the first command signal from the controller, or whether the valve component may have got stuck and not “reached” to the desired valve component position.

Responsive to determining that the real-time valve component position is different from the desired valve component position, the controller may determine that the valve assembly/valve component may be malfunctioning and may accordingly perform a predetermined remedial action (“predefined action”). In some aspects, the predetermined action may include adjusting a water heating system parameter (which may be, for example, adjusting a tank temperature, set point, or other operating parameter).

In some aspects, to effectively perform the predefined action, the controller may first determine whether the valve component is stuck at a “full-hot” position, a “full-cold” position, or at an intermediate position between the full hot and full cold positions, based on the inputs obtained from the position sensor. The controller may adjust the tank temperature (i.e., temperature of the hot water stored in the system water tank) to the desired water temperature when controller determines that the valve component may be stuck at the “full-hot” position. In some aspects, the controller may adjust the tank temperature by switching off the water heating elements. Further, the controller may adjust the tank temperature corresponding to the intermediate position of the “stuck” valve component (e.g., based on a percentage of the movement of the valve component towards the “full-cold” position) when the valve component may be stuck at the intermediate position.

In some aspects, the predetermined action may further include outputting a notification or alert (e.g., a first notification) to a user device associated with the user and/or the system's user interface.

In some aspects, the valve assembly may also act as a “shut-off” valve in which the valve assembly may shut off water flow into and from the system. The valve assembly may shut off the water flow when there may be a leakage in the system water tank (as detected by a leakage detector of the water heating system). In some aspects, the controller may transmit a second command signal(s) to the actuator and cause the movement of the valve component to a shut-off position when there is a leakage in the water tank. The controller may further obtain inputs from the position sensor and determine whether the real-time valve component position is equivalent to the shut-off position. Responsive to a determination that the real-time valve component position is different from the shut-off position, the controller may output a second notification or alert to the user device and/or the system's user interface.

The present disclosure is directed to a water heating system that may include an electronic valve assembly with a position sensor, which facilitates in the detection of a fault in the valve assembly (or to determine if the valve assembly may be malfunctioning). In addition, the system automatically performs adjustments of water heating system parameters to regulate the temperature of the output water, when the valve assembly may be malfunctioning, and/or provides timely alert notifications which may enhance user's experience of using/managing the water heating system.

Although certain examples of the disclosed technology are explained in detail herein, it is to be understood that other examples, embodiments, and implementations of the disclosed technology are contemplated. Accordingly, it is not intended that the disclosed technology is limited in its scope to the details of construction and arrangement of components expressly set forth in the following description or illustrated in the drawings. The disclosed technology can be implemented in a variety of examples and can be practiced or carried out in various ways. In particular, the presently disclosed subject matter is described in the context of being a water heating system and method using a valve assembly. The present disclosure, however, is not so limited, and can be applicable in other contexts. Further, the present disclosure, for example and not limitation, can be applied to water heating systems such as residential water heaters, industrial water heaters, and other water heating systems configured to heat water. Furthermore, the present disclosure can include other fluid heating systems configured to heat a fluid other than water such as process fluid heaters used in industrial applications. Such implementations and applications are contemplated within the scope of the present disclosure. Accordingly, when the present disclosure is described in the context of being a water heating system and method using the valve assembly, it will be understood that other implementations can take the place of those referred to.

Although the term “water” is used throughout this specification, it is to be understood that other fluids may take the place of the term “water” as used herein. Therefore, although described as a water heating system, it is to be understood that the system and methods described herein can apply to fluids other than water. Further, it is also to be understood that the term “fluid” can replace the term “water” as used herein unless the context clearly dictates otherwise. The fluid heating systems may include gas furnaces, electric heating elements, and/or heat pump systems or the like for heating the fluid.

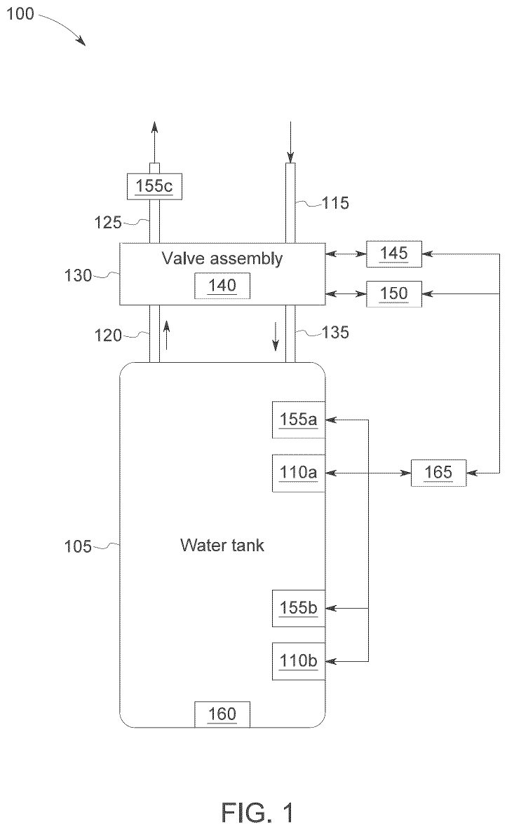

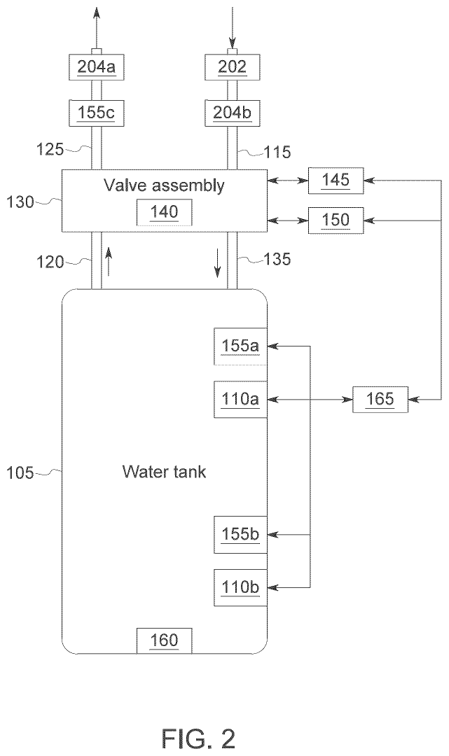

Turning now to the drawings, FIG. 1 depicts a schematic illustration of a first example water heating system 100 (or system 100) in accordance with one or more embodiments of the present disclosure. While describing FIG. 1, references will be made to FIG. 2. The system 100 may heat water to be used in a residential, a commercial, or an industrial application. The system 100 may utilize any type of heating systems. For example, the system 100 may include a gas heating system, an electric element heating system, and/or a heat pump heating system.

The system 100 may include a water tank 105 that may be disposed within a system 100 casing/housing/jacket (not shown). The water tank 105 may be configured to receive a supply of cold water, and store water. The water tank 105 may be made of any material such as steel, copper, and/or the like. The water tank 105 may be insulated to maintain water temperature inside the water tank 105. The water tank 105 may be of any shape. In an exemplary aspect, the water tank 105 may conform to a system 100 shape. For example, the water tank 105 may be cylindrical in shape. The water tank 105 may be of any suitable size or configuration.

The system 100 further may include heating elements 110a, 110b (collectively referred as heating elements 110) that may be configured to heat the water stored in the water tank 105. The heating elements 110 may include any type of available heating systems, e.g., electric heating elements, gas heating elements, heat pump, solar, etc. In some aspects, the heating element 110a may be disposed at an upper portion of the water tank 105, and the heating element 110b may be disposed at a lower portion of the water tank 105. In alternative aspects, the system 100 may include a single heating element that may be located at any position relative to the water tank 105.

The system 100 may further include a cold water conduit 115, a hot water conduit 120, and an outlet water conduit 125 (or output water conduit 125). The cold water conduit 115 may be configured to receive a supply of cold water from an independent water source located outside the system 100 (e.g., a supply of cold water from a utility water source or the like).

The hot water conduit 120 may be configured to receive the hot water from the water tank 105. The outlet water conduit 125 may be configured to output water to different external units, such as sinks, showers, bathtubs, faucets, etc. In some aspects, the outlet water conduit 125 may be configured to output heated/hot water at a desired water temperature, which may be set by a system user in the system 100.

The system 100 may further include a valve assembly 130 that may be in fluid communication with the cold water conduit 115, the hot water conduit 120, and the outlet water conduit 125. In some aspects, the valve assembly 130 may be configured to receive cold water from the independent source via the cold water conduit 115, and hot water from the water tank 105 via the hot water conduit 120. The valve assembly 130 may be configured to blend the cold water and the hot water so that the water in the valve assembly 130 may be at the desired water temperature. The valve assembly 130 may further output the blended water or temperature-regulated water to the outside via the outlet water conduit 125. Thus, the valve assembly 130 may act as a mixing valve and mix/blend the cold water and the hot water and output the blended water at the desired water temperature.

In some instances, the valve assembly 130 may include a valve and a mixing chamber/mixer (not shown). The mixing chamber may be a compartment in which the cold water may be blended with the hot water. The valve may be configured to control a supply of cold and/or hot water to the mixing chamber. In some aspects, the mixing chamber may be separate from the valve. In other aspects, the mixing chamber may be a part of the valve itself.

In some aspects, the valve assembly 130 may also act as a shut-off valve and may shut off the water intake into the system 100 and water output from the system 100 when a predetermined condition is met. For example, the valve assembly 130 may stop a water flow from the cold water conduit 115 (e.g., to the water tank 105 and the outlet water conduit 125) and from the hot water conduit 120 (e.g., to the outlet water conduit 125) when a leakage is detected in the water tank 105 or when the system 100 is being cleaned. Thus, the valve assembly 130 may be a “combination valve” that may act as a mixing valve in a one operational mode and act as a shut-off valve in another operational mode.

In an exemplary aspect, the valve assembly 130 may act as a single/unified manifold for the water tank 105. Specifically, the water tank 105 may receive the cold water supply from the valve assembly 130 via a conduit 135, and the water tank 105 may output the hot water (alone or mixed with cold water) to the outside via the valve assembly 130.

In some aspects, the valve assembly 130 may be located within or inside the system 100 casing. Stated another way, the valve assembly 130 may not be visible to a user from outside when the user views the system 100 casing. In further aspects, the valve assembly 130 may be located at an exterior surface of the system 100 casing. In yet another aspect, one or more components of the valve assembly 130 may be located within the system 100 casing, and remaining components of the valve assembly 130 may be located outside the system 100 casing. In further aspects, the valve assembly 130 may be located in proximity to the system 100 casing top end. In alternative embodiments, the valve assembly 130 may be located anywhere on the system 100 casing.

In an exemplary embodiment, the valve assembly 130 may be attached to the cold water conduit 115 and the hot water conduit 120. In further aspects, one portion (e.g., the valve described above) of the valve assembly 130 may be attached to the cold water conduit 115, and another portion (e.g., the mixing chamber described above) of the valve assembly 130 may be attached to the hot water conduit 120. The valve assembly 130 may be located at any suitable location about the system 100.

The valve assembly 130 may further include a plurality of components including, but not limited to, a cold port, a hot port, an outlet port, a water tank port a valve component 140, and/or the like. The cold port may be connected to the cold water conduit 115 and may be configured to receive cold water therefrom. The hot port may be connected to the hot water conduit 120 and may be configured to receive hot water from the water tank 105. The outlet port may be connected to the outlet water conduit 125 and may be configured to output blended water (mixture of cold and hot water) to the outlet water conduit 125. The water tank port that may be configured to connect the cold water supply from the cold port to the water tank 105 via the conduit 135.

The valve component 140 may be a movable component configured to move and enable the valve assembly 130 to output water at the desired water temperature. Specifically, the valve component 140 may be configured to move relative to its nominal position to change a ratio of hot and cold water in the mixing chamber, thus changing the water temperature in the mixing chamber. In some aspects, the valve component 140 may be configured to open or close the entry of water supply from the cold port and/or the hot port to the mixing chamber to change the water temperature in the mixing chamber. In an exemplary aspect, the valve component 140 may be a spool that may move linearly along its longitudinal or primary axis. In another aspect, the valve component 140 may be a rotary spool with integral porting that allows flow control by rotating the spool about its primary axis. In yet another aspect, the valve component 140 may be a rotary disc that may control flow by directly opening and closing ports by rotating about its primary axis. In some aspects, the valve component 140 may move between a “full-hot” position and a “full-cold” position. In the “full-hot” position, the valve component 140 may completely close the entry of water supply from the cold port to the mixing chamber, and in the “full-cold” position, the valve component 140 may close the entry of the water supply from the hot port to the mixing chamber. Intermediate positions between the “full-hot” and “full-cold” positions may provide different ratios of hot and cold water to the mixing chamber to provide water at a desired output temperature.

The system 100 may further include an actuator 145 that may be configured to actuate the valve assembly 130 or change its operational state. In some aspects, the actuator 145 may be configured to control the mechanical movement of one or more components of the valve assembly 130 and enable the valve assembly 130 to operate in a first operation mode (in which the valve assembly 130 mixes the hot and cold water) or a second operation mode (in which the valve assembly 130 shuts off the supply of water). Specifically, the actuator 145 may control the mechanical movement of the valve component 140 to cause the valve assembly 130 to operate in the first or second operation state. The actuator 145 may include, for example, a stepper motor, a servo motor, a linear actuator, a solenoid-operated water valve, a gear/motor driven water valve, a brushed DC motor paired with an optical position wheel, and/or the like. The actuator 145 may include any type of suitable actuating system.

In some aspects, the actuator 145 may be disposed on an exterior surface of the system 100 casing. In other aspects, the actuator 145 may be disposed within the system 100 casing. The actuator 145 may be located in proximity to (or adjacent to) or form a part of the valve assembly 130.

The system 100 may additionally include a position sensor 150 that may be configured to monitor a real-time valve component 140 position in the valve assembly 130. Stated another way, the position sensor 150 may detect the real-time position of the valve component 140. In some aspects, the position sensor 150 may be located in proximity to (or adjacent to) or form a part of the valve assembly 130. In further aspects, the position sensor 150 may be located in proximity to (or adjacent to) the valve component 140. In additional aspects, the position sensor 150 may be located in proximity to (or adjacent to) the actuator 145. The position sensor 150 may be, for example, a linear position sensor, a rotary position sensor, a magnetic position sensor, a Hall Effect sensor, a potentiometer, and/or the like. The position sensor 150 may include any type of suitable position sensor. In some aspects, the position sensors may be positioned at predetermined locations. A controller (e.g., a controller 165, described later in the present disclosure) may use measurements from the position sensor 150 and operation of the actuator 145 to determine the position of the valve 140. Stated another way, the determination of the position of the valve 140 may be made based on the measurements from the position sensor 150 in combination with the operation of the actuator 145.

The system 100 may further include additional sensors including, but not limited to, temperature sensors 155a, 155b, 115c (collectively referred as temperature sensors 155), a leakage sensor 160, and/or the like. The leakage sensor 160 may be configured to detect a water leakage in the water tank 105 or other components of the system 100. The temperature sensor(s) 155 may be configured to detect water temperature. In an exemplary aspect, the temperature sensors 155a and 155b may detect temperature of hot water stored in the water tank 105. Further, the temperature sensor 155c may detect temperature of water flowing out of or being discharged from the outlet water conduit 125. The temperature sensor(s) 155 may include thermocouples, resistor temperature detectors, thermistors, infrared sensors, semiconductors, or any other type of sensor that would be appropriate for a given use or application.

In addition, in some aspects, the system 100 may include a supply temperature sensor 202 and flow rate sensors 204a, 204b (collectively referred as flow rate sensor 204), as shown in FIG. 2. The flow rate sensor(s) 204 may be configured to determine a rate of water flow into the system 100 or the rate of water flow dispensed out from the system 100 (e.g., via the cold water conduit 115 and the outlet water conduit 125, respectively). The supply temperature sensor 202 may detect the temperature of water entering the water tank 105 (or the valve assembly 130) from the cold water conduit 115. The supply temperature sensor 202 may be similar to the temperature sensor(s) 155.

The system 100 may include other sensors or components as well. Examples of such sensors or components include, but are not limited to, a pressure sensor, a scale, a voltmeter, an ammeter, a power meter, an ohmmeter, a resistance temperature detector, environment condition sensors including ambient air temperature sensor, humidity sensors, and/or the like. These other sensors or components are not shown in FIGS. 1 and 2 for the sake of simplicity and conciseness.

The system 100 may further include a controller 165 that may communicatively couple with the actuator 145, the position sensor 150, and additional sensors (including the temperature sensor(s) 155, the leakage sensor 160, the supply temperature sensor 202 and the flow rate sensor 204). The controller 165 may be configured to receive inputs from the sensors described above and control the system elements and parameters to output the water from the system 100 at the desired water temperature. In some aspects, the controller 165 may be configured to provide/transmit signals (e.g., command signals) to the actuator 145 to control the valve component 140 movement, to ensure that the valve assembly 130 outputs the water at the desired water temperature. In this manner, the controller 165 controls the temperature of output water from the outlet water conduit 125. As an example, the controller 165 may transmit a command signal (e.g., a first command signal) to the actuator 145 to cause movement of the valve component 140 to a desired valve component position, which may enable the valve assembly 130 to output water at the desired water temperature.

In some aspects, the controller 165 may be disposed on the exterior surface of the system 100 casing. In other aspects, the controller 165 may be disposed within the system 100 casing (e.g., at the system 100 casing interior surface). In an exemplary aspect, the controller 165 may be located in proximity to the valve assembly 130, the actuator 145, and/or the sensors described above. The details of the controller 165 operation are described below.

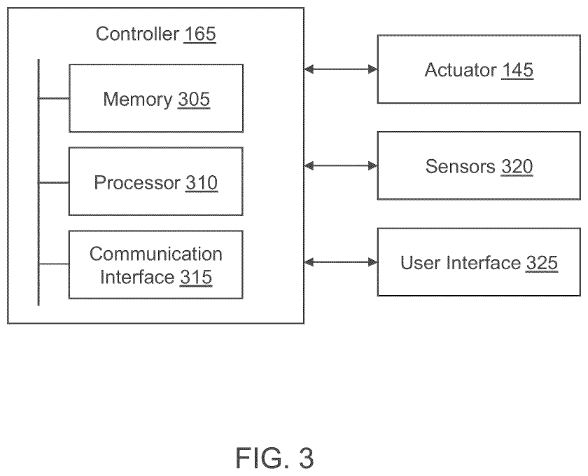

In operation, the controller 165 may receive the desired water temperature and/or a desired tank temperature in the water tank 105. In some aspects, the controller 165 may receive the desired water temperature and/or the desired tank temperature from a system user, e.g., via a system's user interface (e.g., a user interface 325 shown in FIG. 3, which may be disposed on the system 100 casing outer surface or located at a remote location) or a user device.

The controller 165 may further receive/obtain a real-time tank temperature associated with the water tank 105 (or the temperature of the hot water stored in the water tank 105) via temperature sensor(s) 155 (e.g., the temperature sensors 155a, 155b) located inside the water tank 105. Responsive to receiving the temperatures described above, the controller 165 may compare the desired water temperature and the real-time tank temperature, and determine (or select) a desired valve component 140 position based on the comparison, to ensure that the valve assembly 130 outputs the water at the desired water temperature.

The controller 165 may select the desired valve component 140 position as either “full-hot” position, “full-cold” position, or an intermediate position between the “full-hot” position and the “full-cold” position, based on the difference between the desired water temperature and the real-time tank temperature. In some aspects, the controller 165 may select the “full hot” position when the desired water temperature may be equivalent to the tank temperature (or the temperature of the hot water stored in the water tank 105). Further, the controller 165 may select the intermediate position when the desired water temperature may be less than the tank temperature. For example, the controller 165 may select the intermediate position between the “full-hot” position and the “full-cold” position when the desired water temperature is 120° F. and the tank temperature is 140° F., so that the valve assembly 130 outputs the water at 120° F. Furthermore, the controller 165 may select the “full cold” position when the desired water temperature may be equivalent to the water temperature of the supplied cold water.

Responsive to determining/selecting the desired valve component 140 position, the controller 165 may cause movement of the valve component 140 to the desired valve component 140 position via the actuator 145. In particular, the controller 165 may transmit the first command signal to the actuator 145 to cause the movement of the valve component 140 to the desired valve component 140 position, to control the temperature of the water that may be getting dispensed from the outlet water conduit 125. When the valve component 140 is positioned at the desired valve component 140 position, the valve assembly 130 may output the water at the desired water temperature (e.g., 120° F.).

In further aspects, the controller 165 may receive inputs from other sensors as well and calculate the desired valve component 140 position based on the inputs obtained from the other sensors. For example, the controller 165 may obtain inputs from the supply temperature sensor 202, the flow rate sensor(s) 204, etc., and may calculate the desired valve component 140 position based on the obtained inputs. As an example, the controller 165 may compare the temperature of the water entering the water tank 105 with the desired water temperature and may calculate or select the “full-cold” position as the desired valve component 140 position when the temperature of water entering the water tank 105 is equivalent to the desired water temperature.

In further aspects, the controller 165 may further receive real-time inputs from the temperature sensor 155c and compare the temperature of the water flowing out of or getting discharged from the outlet water conduit 125 with the desired water temperature. Based on the comparison, the controller 165 may determine whether the temperature of the discharged water is equivalent to the desired water temperature. Responsive to a determination that the temperature of the discharged water is not equivalent to the desired water temperature, the controller 165 may calculate an updated position of the valve component 140 in real-time based on the inputs obtained from the sensors described above, so that the temperature of the discharged water becomes equivalent to the desired water temperature. The controller 165 may then transmit a second command signal to the actuator 145 to cause the movement of the valve component 140 to the updated valve component 140 position, to ensure that the valve assembly 130 outputs the water at the desired water temperature. The controller 165 may be a proportional-integral-derivative (PID) or proportional-integral (PI) controller that may utilize a closed-loop feedback control mechanism that continuously adjusts outputs (e.g., the desired valve component 140 position) based on the difference between the desired water temperature and the measured temperature of the discharged water.

In some aspects, the controller 165 may be a machine-learning based controller that may use machine learning to determine/calculate the desired valve component 140 position. For example, during a hot water demand event when hot water is being drawn from the water tank 105, the temperature of the water sensed by the temperature sensor(s) 155 may change over time. Based on the real-time feedback from the temperature sensor(s) 155, the controller 165 may adjust the valve component 140 position to continue to discharge water at the desired water temperature. Other control schemes and control algorithms for evaluating sensor data and adjusting the desired valve component 140 position are contemplated by this disclosure.

In an exemplary aspect, when the valve component 140 is in the “full cold” position, and the temperature of the discharged water from the outlet water conduit 125 drops below the desired water temperature, the controller 165 may move the valve component 140 to an intermediate position to reduce the supply of cold water to the valve assembly 130 and increase the supply of hot water towards the valve assembly 130 (and hence towards the outlet water conduit 125), and may find a steady state position within a few seconds (e.g., 30 seconds). As the water tank 105 depletes, the controller 165 may move/actuate the valve component 140 to introduce more “hot” water from the water tank 105 to maintain the desired water temperature and may then stop drawing the water from the water tank 105. As the water tank 105 recovers and exceeds the desired water temperature, the controller 165 may move/actuate the valve component 140 back to the “full-cold” position.

In some aspects, responsive to transmitting the first command signal to the actuator 145 to move the valve component 140 to the desired valve component 140 position (or when the controller 165 may be controlling the movement of the valve component 140), the controller 165 may receive/obtain inputs from the position sensor 150. Specifically, the controller 165 may obtain inputs associated with the real-time valve component 140 position from the position sensor 150. In some aspects, the controller 165 may obtain the inputs associated with the real-time valve component 140 position responsive to transmitting the first command signal to the actuator 145. The controller 165 may obtain the inputs from the position sensor 150 at a predefined frequency or at specified time durations.

Responsive to obtaining the inputs associated with the real-time valve component 140 position, the controller 165 may compare the real-time valve component 140 position with the desired valve component 140 position. Based on the comparison, the controller 165 may verify that the real-time valve component 140 position is equivalent to the desired valve component 140 position. Responsive to determining that the real-time valve component 140 position is equivalent to the desired valve component 140 position, the controller 165 may determine that the valve assembly 130 or the valve component 140 may be working normally/optimally.

On the other hand, responsive to determining that the real-time valve component 140 position is not equivalent to the desired valve component 140 position, the controller 165 may determine that the valve assembly 130 may be malfunctioning. For example, in this case, the controller 165 may determine that the valve component 140 may be stuck or jammed. When the real-time valve component 140 position is different from the desired valve component 140 position, the controller 165 may perform one or more predetermined remedial actions. In some aspects, the predetermined remedial actions may include outputting a first notification or alert (e.g., an email notification or an audio alert) on the user device and/or the system's user interface. Examples of additional predetermined actions are described below.

Responsive to determining that the real-time valve component 140 position is not equivalent to the desired valve component 140 position, in some aspects, the controller 165 may first determine whether the real-time valve component 140 position is the “full-hot” position, the “full-cold” position, or the intermediate position between the “full-hot” position and the “full-cold” position, based on the inputs obtained from the position sensor 150. Responsive to determining this information, the controller 165 may control a water heater parameter (e.g., the tank temperature), to ensure that the valve assembly 130 outputs the heated water at the desired water temperature.

In some aspects, the controller 165 may obtain the tank temperature (e.g., real-time tank temperature) from the temperature sensor 155 when the controller 165 determines that the real-time valve component 140 position is the “full-hot” position. Responsive to the obtaining the tank temperature, the controller 165 may compare the tank temperature with the desired water temperature. The controller 165 may control/adjust the tank temperature to the desired water temperature when the tank temperature may be greater than the desired water temperature. For example, when the desired water temperature is 120° F. and the tank temperature is 140° F., the controller 165 may limit the tank temperature to 120° F. when the valve component 140 is stuck at the “full-hot” position. In some aspects, to control or limit the tank temperature, the controller 165 may override the desired tank temperature or the desired set point(s) of the heating element(s) 110. Specifically, the controller 165 may update the desired set point(s) of the heating element(s) 110 to ensure that the tank temperature becomes equivalent to the desired water temperature. In further aspects, to control or limit the tank temperature, the controller 165 may turn-off the heating element(s) 110. Stated another way, the controller 165 may adjust an operational state of the heating element(s) 110 to control or limit the tank temperature.

In some aspects, when the controller 165 determines that the valve component 140 is stuck at an intermediate position and the tank temperature is greater than the desired water temperature, the controller 165 may control the tank temperature to a first water temperature (that may be greater than the desired temperature). The controller 165 may determine the first water temperature based on the stuck intermediate position of the valve component 140. Stated another way, the first water temperature corresponds to the stuck intermediate position of the valve component 140. For example, if the valve component 140 is stuck along the path back to full cold position, the tank temperature may be limited to a corresponding elevated setpoint based on the percentage of travel back towards the full cold position that was achieved. In this manner, the controller 165 may adjust the water heater parameters when the valve component 140 may be stuck or jammed at any position. In some aspects, the controller 165 may adjust the water heater parameters based on other inputs as well including, but not limited to, the supply temperature (or temperature of water entering the water tank 105), the water flow rate (of water entering the system 100 or water being dispensed out of the system 100), and/or the like.

In addition, the controller 165 may receive the inputs from the leakage sensor 160 and determine that there may be a leakage in the water tank 105 based on the inputs obtained from the leakage sensor 160. Responsive to determining that there is a leakage in the water tank 105, the controller 165 may transmit a third command signal to the actuator 145 to cause the movement of the valve component 140 to the shut-off position. As described above, in the shut-off position, the valve assembly 130 stops a water flow from the cold water conduit 115 and from the hot water conduit 120. Stated another way, the controller 165 may cause the valve component 140 to close both the cold port and the hot port of the valve assembly 130 in the shut-off position. Thus, when the controller 165 determines that there may be a leakage in the water tank 105, the controller 165 may shut off the water flow into and from the system 100.

In some aspects, responsive to transmitting the third command signal, the controller 165 may receive/obtain the real-time valve component 140 position from the position sensor 150. Responsive to obtaining the real-time valve component 140 position, the controller 165 may compare the real-time valve component 140 position with the shut-off position. Based on the comparison, the controller 165 may verify that the real-time valve component 140 position is equivalent to the shut-off position. Responsive to a determination that the real-time valve component 140 position is equivalent to the shut-off position, the controller 165 may determine that the valve assembly 130 is working normally/optimally. On the other hand, responsive to a determination that the real-time valve component 140 position is not equivalent to the shut-off position, the controller 165 may determine that the valve assembly 130 may be malfunctioning. Responsive to such determination, in this case, the controller 165 may output a second notification or alert (e.g., email notification or audio alert) to the system's user interface and/or the user device.

In additional aspects, the controller 165 may be configured to activate a valve cleaning mode or an anti-fouling cycle. In this case, the controller 165 may transmit a fourth command signal to the actuator 145 to trigger the valve cleaning mode. In some aspects, the controller 165 may activate the valve cleaning mode at a predetermined frequency, e.g., once every week. In the valve cleaning mode, the controller 165 may cause the actuator 145 to move the valve component 140 longitudinally back and forth or rotate between a fully open and fully closed position at a predefined rate, so that the valve assembly 130 may perform self-cleaning operation. In some instances, the valve cleaning mode may be implemented based on a predefined frequency, a command signal from the system user (e.g., via the user device or the system's user interface), an external command received from the controller 165, or as commanded by the controller 165 based on a usage profile of the water tank 105 and/or a perceived condition of the water tank 105 or of the water within the water tank 105.

In some aspects, the controller 165 may determine a valve blockage (e.g., valve blockage due to the presence of debris, scaling, etc. in one or more valve openings) and may activate the valve cleaning mode responsive to the determination of the valve blockage. An exemplary process of determining the valve blockage is described below.

In some aspects, the controller 165 may receive information associated with the desired water temperature and may adjust the valve component 140 position (e.g., adjust the valve “opening”) based on the desired water temperature. The controller 165 may also confirm that the real-time valve component 140 position is equivalent to the adjusted valve component 140 position based on the inputs obtained from the position sensor 150. Thereafter, the controller 165 may determine the real-time temperature of water flowing out of or being discharged (obtained via the temperature sensor 155c) from the system. The controller 165 may then compare the desired water temperature and the real-time water temperature. If the real-time water temperature is different from the desired water temperature (e.g., lower or greater than the desired water temperature), the controller 165 may determine that the valve assembly 130 may be blocked due to the presence of debris, scaling, etc. Responsive to such determination, the controller 165 may activate the valve cleaning mode to remove the debris from the valve assembly 130 (e.g., from different pathways of the valve assembly 130).

Furthermore, responsive to such determination, the controller 165 may further increase the valve opening percentage to make the real-time water temperature equivalent to the desired water temperature. Stated another way, in this case, the controller 165 may adjust the valve component 140 position (e.g., to allow more cold or hot water to enter the mixing chamber) in normal operation mode based on the determination of the valve blockage to ensure that the valve assembly 130 outputs the water at the desired water temperature. Thus, the valve assembly 130 outputs the water at the desired water temperature even when there is a valve blockage due to debris. Stated another way, the valve assembly 130 may be debris-tolerant.

FIG. 3 depicts a block diagram of the controller 165 in accordance with one or more embodiments of the present disclosure. The controller 165 may include a plurality of components including, but not limited to, a memory 305, a processor 310 and a communication interface 315. The controller 165 may be a computing device configured to receive data, determine actions based on the received data and output a control signal instructing one or more water heating system 100 components to perform one or more actions. As described above, the controller 165 may be a part of the water heating system 100, and the controller 165 may be in communication with at least some of the water heating system 100 components.

In some aspects, the controller 165 may be configured to send and receive wireless or wired signals, and the signals may be analog or digital signals. The wireless signals may include Bluetooth™, BLE, WiFi™, ZigBee™, infrared, microwave radio, or any other type of wireless communication signals as may be suitable for a particular water heating system 100 application. The hard-wired signals can include communication signals between any directly wired connections between the controller 165 and other water heating system 100 components. For example, the controller 165 can have a hard-wired 24 Volts Direct Current (VDC) connection to a plurality of sensors 320 of the system 100.

Alternatively, the controller 165 may communicate with the plurality of sensors 320 via a digital connection. The sensors 320 may include, but are not limited to, the position sensor 150, the temperature sensors 155 (and the supply temperature sensor 202), the leakage sensor 160, the flow rate sensor 204, etc. The digital connection can include a connection such as an Ethernet or a serial connection and can utilize any suitable communication protocol for the water heating system 100 application, such as Modbus, fieldbus, PROFIBUS, SafetyBus, Ethernet/IP, and/or the like. Furthermore, the controller 165 can utilize a combination of wireless, hard-wired, and analog or digital communication signals to communicate with and control the various water heating system 100 components. The above configurations are given merely as non-limiting examples and the actual configuration can vary depending on the particular water heating system 100 application.

The memory 305 may be configured to store a program and/or instructions associated with the functions and methods described herein. The processor 310 may be configured to execute the program and/or instructions stored in the memory 305. The memory 305 can include one or more suitable types of memory (e.g., volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like) for storing files including the operating system, application programs (including, for example, a web browser application, a widget or gadget engine, and or other applications, as necessary), executable instructions and data. One, some, or all of the processing techniques or methods described herein can be implemented as a combination of executable instructions and data within the memory 305.

The communication interface 315 may be configured to send or receive communication signals between the various water heating system 100 components. The communication interface 315 can include hardware, firmware, and/or software that allows the processor 310 to communicate with the other components via wired or wireless networks, whether local or wide area, private or public, as known in the art. The communication interface 315 can also provide access to a cellular network, the Internet, a local area network, or another wide-area network as suitable for the particular water heating system 100 application.

Additionally, the controller 165 may have or be in communication with a user interface 325 (which may be, e.g., a water heating system 100 Human Machine Interface (HMI)) for displaying water heating system 100 information and receiving inputs from the user. In some instances, the user interface 325 may be installed locally on the water heating system 100 (e.g., on system 100 casing outer surface). The user, for example, can view water heating system 100 data on the user interface 325 and input data or commands to the controller 165 via the user interface 325. For example, the user can view water heating system 100 temperature settings (or any other setting) on the user interface 325 and provide inputs to the controller 165 via the user interface 325 to change the settings. For example, the user may provide information associated with the desired water temperature of heated water, the desired tank temperature, water usage/demand, desired time to heat the water, etc.

In some aspects, the controller 165 may be configured to control the operation of the valve assembly 130. For example, the controller 165 may obtain inputs from the plurality of sensors 320 and may trigger the valve component 140 movement to ensure that the valve assembly 130 outputs the heated water at the desired water temperature. In addition, the controller 165 may adjust the water heater parameters when the valve assembly 130 may be malfunctioning. The details of the controller 165 operation are already described above in conjunction with FIGS. 1 and 2.

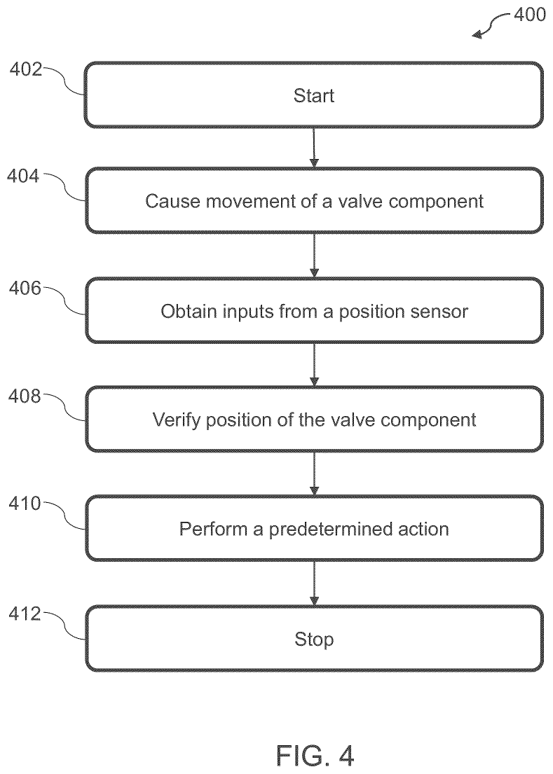

FIG. 4 depicts a flow diagram of an example method 400 to control the water heating system 100 in accordance with one or more embodiments of the present disclosure. FIG. 4 may be described with continued reference to prior figures, including FIGS. 1-3. The following process is exemplary and not confined to the steps described hereafter. Moreover, alternative embodiments may include more or less steps that are shown or described herein and may include these steps in a different order than the order described in the following example embodiments.

The method 400 may start at step 402. At step 404, the method 400 may include causing, by the controller 165, the movement of the valve component 140 to the desired valve component position. At step 406, the method 400 may include obtaining, by the controller 165, the inputs from the position sensor 150. For example, the controller 165 may obtain the inputs associated with the real-time valve component position from the position sensor 150.

At step 408, the method 400 may include verifying, by the controller 165, the position of the valve component position. For example, the controller 165 may verify that the real-time valve component position is equivalent to the desired valve component 140 position. At step 410, the method 400 may include performing, by the controller 165, the predetermined remedial actions when the real-time valve component position is different from the desired valve component position. The examples of the predetermined remedial actions are described above in conjunction with FIGS. 1 and 2.

The method 400 may end at step 412.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A water heating system comprising:
a valve assembly configured to receive cold water and hot water, blend the cold water and the hot water, and output a blended water at a desired water temperature based on a valve component position;
a position sensor configured to monitor a valve component position; and
a controller configured to:
cause a movement of a valve component of the valve assembly to a desired valve component position;
verify that the valve component position is equivalent to the desired valve component position based on inputs obtained from the position sensor; and
perform a predetermined action when the valve component position is different from the desired valve component position.

2. The water heating system of claim 1, further comprising an actuator configured to control mechanical movement of the valve component, wherein the controller is configured to transmit a command signal to the actuator to cause the movement of the valve component to the desired valve component position.

3. The water heating system of claim 2, wherein the actuator is a stepper motor, a servo motor, a brushed DC motor paired with an optical position wheel, or a linear actuator.

4. The water heating system of claim 2, wherein the controller is further configured to:
determine the desired valve component position based on the desired water temperature and a tank temperature of hot water stored in a water tank of the water heating system; and
cause the movement of the valve component to the desired valve component position responsive to the determination.

5. The water heating system of claim 4, wherein the controller is further configured to determine the desired valve component position based on one or more of, a water flow rate of water entering the water heating system or water being dispensed out of the water heating system, or an outlet water temperature associated with water being discharged from the water heating system.

6. The water heating system of claim 5, wherein the controller is further configured to:
obtain the inputs from the position sensor responsive to a transmission of the command signal to the actuator;
compare the valve component position with the desired valve component position based on the inputs; and
verify that the valve component position is equivalent to the desired valve component position based on the comparison.

7. The water heating system of claim 1, wherein, to perform the predetermined action, the controller is further configured to:
determine whether the valve component position is equivalent to a full-hot position, a full-cold position, or an intermediate position between the full-hot position and the full-cold position based on the inputs obtained from the position sensor; and
control a water heating system parameter based on the determination.

8. The water heating system of claim 7, wherein the controller is further configured to:
obtain a tank temperature from a tank temperature sensor, responsive to a determination that the valve component position is equivalent to the full-hot position;
compare the tank temperature with the desired water temperature; and
cause the tank temperature to become equivalent to the desired water temperature when the tank temperature is greater than the desired water temperature.

9. The water heating system of claim 8, wherein the controller is further configured to cause the tank temperature to become equivalent to a first water temperature responsive to determining that the valve component position is equivalent to the intermediate position, and wherein the controller is further configured to determine the first water temperature based on the intermediate position.

10. The water heating system of claim 9, wherein to cause the tank temperature to become equivalent to the desired water temperature or the first water temperature, the controller is further configured to adjust an operational state of a heating element of the water heating system that is configured to heat water in a water tank of the water heating system.

11. The water heating system of claim 1, wherein to perform the predetermined action, the controller is further configured to output a first notification or alert.

12. The water heating system of claim 1, further comprising a leakage sensor configured to detect a leakage in a water tank of the water heating system.

13. The water heating system of claim 12, wherein the controller is further configured to:
obtain inputs from the leakage sensor;
determine that there is a leakage in the water tank based on the inputs obtained from the leakage sensor; and
cause the movement of the valve component to a shut-off position, wherein the valve component is configured to stop a flow of the cold water and the hot water from the valve assembly in the shut-off position.

14. The water heating system of claim 13, wherein the controller is further configured to:
compare the valve component position with the shut-off position responsive to causing the movement of the valve component to the shut-off position; and
verify that the valve component position is equivalent to the shut-off position based on the comparison.

15. The water heating system of claim 14, wherein the controller is further configured to output a second notification or alert when the valve component position is different from the shut-off position.

16. The water heating system of claim 1, wherein the valve component is at least one of a spool or a rotating disc.

17. A water heating system comprising:
a water tank configured to store hot water;
a cold water conduit configured to receive a supply of cold water;
a hot water conduit configured to receive hot water from the water tank;
an output water conduit configured to output water at a desired water temperature;
a valve assembly configured to receive cold water from the cold water conduit and hot water from the hot water conduit, blend the cold water and the hot water, and output a blended water at the desired water temperature from the output water conduit based on a valve component position;
a position sensor configured to monitor a valve component position; and
a controller configured to:
cause a movement of a valve component of the valve assembly to a desired valve component position;
verify that the valve component position is equivalent to the desired valve component position based on inputs obtained from the position sensor; and
perform a predetermined action when the valve component position is different from the desired valve component position.

18. The water heating system of claim 17, further comprising an actuator configured to control mechanical movement of the valve component, wherein the controller is configured to transmit a command signal to the actuator to cause the movement of the valve component to the desired valve component position.

19. The water heating system of claim 17, wherein the controller is further configured to:
determine the desired valve component position based on the desired water temperature and a tank temperature of the hot water stored in the water tank; and
cause the movement of the valve component to the desired valve component position responsive to the determination.

20. A method comprising:
causing, by a controller, a movement of a valve component, associated with a valve assembly, to a desired valve component position, wherein the valve assembly is configured to receive cold water and hot water, blend the cold water and the hot water, and output a blended water at a desired water temperature based on a valve component position;
obtaining, by the controller, inputs from a position sensor configured to monitor a valve component position;
verifying, by the controller, that the valve component position is equivalent to the desired valve component position; and
performing, by the controller, a predetermined action when the valve component position is different from the desired valve component position.
